(19) United States
(12) Patent Application Publication
(10) Pub. No.: US 2003/0131347 A1
(43) Pub. Date: Jul. 10, 2003

(54) Method and apparatus for runtime binding of object members

(76) Inventor: David S. Allison, San Ramon, CA (US)

Correspondence Address: ROSENTHAL & OSHA L.L.P. / SUN, 1221 MCKINNEY, SUITE 2800, HOUSTON, TX, 77010, US

(21) Appl. No.: 09/977,512

(22) Filed: Oct. 12, 2001

(51) Int. Cl. G06F 9/44; G06F 9/45

(52) U.S. Cl. 717/165; 717/148

(57) ABSTRACT

The present invention is a method and apparatus for runtime binding of object members. The invention extends the late binding functionality allowed for virtual functions by static compiled programming languages like C, C++, JAVA, to all class members and class methods (functions) of all objects (classes), including virtual functions. According to one embodiment access to any member or method of any object results in a runtime search to find the member or method and to verify that the member or method exists. This eliminates the need to type cast to get access to members of a derived class. Each member of a class has an access control level associated with it, and according to another embodiment this access control protocol is honored by the runtime search to make sure that the user has access to only public members, and not private members.

### BACKGROUND OF THE INVENTION

1. Field of the Invention

The present invention relates primarily to programming languages, and in particular to a method and apparatus for a runtime binding of object members in a dynamically typed programming language.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Object-oriented programming is becoming increasingly popular because it makes programming easier. It is a useful programming methodology that encourages modular design of the code and software reusability. Object-oriented programming allows the programmer to hide implementation details, turning each object into a member of an abstract data type whose concrete operations and state are encapsulated behind a message-passing interface.

Object-oriented programming languages have a late binding feature that allows polymorphism, which is a powerful tool for abstract data types. The late binding feature, however, does not apply to all functions in prior art object-oriented programming languages like C++ and Java. In prior art object-oriented programming languages, late binding is restricted to virtual functions only. These programming languages have an early binding feature for all other functions, which is less powerful and versatile. Before further discussing the problems associated with early binding, an overview of object-oriented programming is provided.

Object-Oriented Programming

Object-oriented programming is a method of creating computer programs by combining certain fundamental building blocks, and creating relationships among and between the building blocks. The building blocks object-oriented programming systems are called “objects”. An object is a programming unit that groups together a data structure (instance variables) and the operations (methods) that can use or affect that data. Thus, an object consists of data and one or more operations or procedures that can be performed on that data. The joining of data and operations into a unitary building block is “encapsulation”. In object-oriented programming, operations that can be performed on the data are referred to as “methods”.

An object can be instructed to perform one of its methods when it receives a “message”. A message is a command or instruction to the object to execute a certain method. It consists of a method selection (name) and arguments (not necessary) that are sent to an object. A message tells the receiving object what to do.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are generally based on one of two schemes for representing general concepts and sharing knowledge. One scheme is known as the “class” scheme. The other scheme is known as the “prototype” scheme. Both the set-based (“class” scheme) and prototype-based object-oriented programming schemes are generally described in Lieberman, “Using Prototypical Objects to Implement Shared Behavior in Object-Oriented Systems,” OOPSLA 86 Proceedings, September 1986, pp. 214-223.

In accordance with the embodiments of the present invention, the class-based object-oriented scheme will be described.

Class Scheme

An object that describes behavior is called a “class”. Objects that acquire a 20 behavior and that have states are called “instances”. Thus, in the Java™ language, a class is a particular type of object. In Java™, any object that is not a class object is said to be an instance of its class. In C++, a class is defined as follows:

```
class X {
public:
  X(int arg);  // constructor
private:
  int a, b;  // class members
};
```

This structure defines the class to be an encapsulation of a set of members.

Some of the class members are defined as being “special” because they have the same name as the class itself. These members are known as a constructor. A class member can be either a data member, or a variable, or a function, also known as a method.

Object-oriented programming languages that utilize the class/instance/inheritance structure described above implement a set-theoretic approach to sharing knowledge. This approach is used in object-oriented programming languages, such as C++, Smalltalk and Java™. The three main features of an object-oriented programming language are encapsulation, data abstraction, and inheritance, and are discussed next.

Encapsulation

Encapsulation is a technique for minimizing interdependencies among separately-written modules by defining strict external interfaces. If users depend only on external interface, the module can be re-implemented without affecting any users, as long as the new implementation supports the same (or upward compatible) external interface. In his way the effects of compatible changes can be confined.

A module is encapsulated if users are restricted by the definition of the programming language to access the module only via its external interface. Encapsulation thus assures program designers that compatible changes can be made safely, which facilitates program evolution and maintenance. The benefits of this assurance is especially important for large systems, and long-lived data. To maximize the advantages of encapsulation, the exposure to implementation details in external interfaces should be minimized. For example, one characteristic of an object-oriented language is whether it permits a program designer to define a class such that its instance variables can be renamed without affecting users.

Data Abstraction

Data abstraction is a useful form of modular programming. The behavior of an abstract data object is fully defined by a set of abstract operations defined on the object. The user of an object does not need to understand how these operations are implemented, or how the object is represented. Objects in most object-orient programming languages are abstract data objects, where the external interface of an object is the set of operations defined on it. Changes to the representation of an object or the implementation of its operations can be made without affecting users of the object, so long as the externally visible behavior of the operations is unchanged.

A class definition is a module with its own external interface. Minimally, this interface describes how instances of the class are created, including any creation parameters. In many programming languages, a class is itself an object, and its external interface consists of a set of operations, including operations to create instances. In other words, this prime feature, is the ability to define new types of objects whose behavior is defined abstractly, without reference to implementation details such as the data structure used to represent the objects. The user of an object does not need to understand how these operations are implemented or how the object is represented.

Inheritance

Inheritance complicates the situation by introducing a new category of clients for a class. In addition to clients that simply instantiate objects of the class and perform operations on them, there are other clients (class definitions) that inherit from the class. To fully characterize an object-oriented language, the external interfaces provided by a class to its children have to be considered. This external interface is just as important as the external interface provided to users of the objects, as it serves as a contract between the class and its children, and thus limits the degree to which the program designer can safely make changes to the class. For example, JAVA calls the parent class as the super or base class, and its children are the sub classes.

For example, if a class called “Employee” is created for a company that has managers that are treated substantially different from the other employees as far as their raises are computed, or their access to a secretary, etc., then a new class called “Manager” can be defined. This new class can have additional functionality, but all the instance fields of the original class can be preserved. More abstractly, there is an obvious “is-a” relationship between “Manager” and “Employee” class. Every manager is an employee: this “is-a” relationship is the hallmark of inheritance. An example of a super class in C++ is shown below.

class X {
public:

int x;
// other members of X

};

Then a class derived from the super class, X, is termed as a sub class and defined as:

class Y: public X {
public:

// other members of Y

};

Y inherits the accessible members of X. In this example, class Y has a member ‘int x’ inherited from class X.

FIG. 1 is a block diagram that illustrates inheritance. Class 1 (generally indicated by block 100) defines a class of objects that have three methods in common, namely, A, B and C. An object belonging to a class is referred to as an “instance” of that class. An example of an instance of class 1 is block 110. An instance such as instance 110 contains all the methods of its parent class. Block 110 contains methods A, B and C. As discussed, each class may also have subclasses, which also share all the methods of the parent or super class. Sub class 1.1 (indicated by block 120) inherits methods A, B and C and defines an additional method D. Each sub class can have its own instances, such as, for example, instance 130. Each instance of a sub class includes all the methods of the sub class. In the example, instance 130 includes methods A, B, C and D of sub class 1.1.

Virtual Functions

Suppose a set of shape classes such as “Circle”, “Triangle”, “Square”, etc. are all derived from a base class “Shapes”. In object-oriented programming, each of these classes may have the capability to draw itself. Although each class has its own draw function, the draw function for each shape is very different from the rest. One functionality of object-orient programming is to be able to treat all these shapes generically as objects of the base class Shapes. Then in order to draw any shape, the draw function of the base class is called upon which lets the program determine dynamically (i.e. at execution time) which derived class draw function to use.

In order to accomplish this, the draw function in the base class is defined as a virtual function, and separate draw functions are defined in each of the derived classes to draw the appropriate shape. If function draw in the base class has been declared virtual, and if a base-class pointer is used to point to the derived-class object and invoke the draw function using a pointer, for example, shapePtr→draw ( ), the program chooses the correct derived class's draw function dynamically (called dynamic binding).

Virtual functions can work nicely if all possible classes are known in advance. But they also work when new kinds of classes are added to the system via dynamic (or late) binding. Dynamic binding requires that at execution time, the call to a virtual member function is routed to the virtual function version appropriate for the class. A virtual function table, commonly called a vtable, is usually used to implement the function pointers in an array. For each virtual function in the class, the vtable has an entry containing a function pointer to the version of the virtual function to use for an object of that class.

The virtual function to use for a particular class can be the function defined in that class or it could be a function inherited either directly or indirectly from a base class higher in the hierarchy. At execution time, polymorphic calls to the virtual functions of the objects dereference the vtable pointer in the object to obtain the vtable for the class. Then, the appropriate function pointer in the vtable is obtained and dereferenced to complete the call at execution time. This vtable lookup and pointer dereferencing requires nominal execution time overhead.

Binding

When a program is instantiated, there are two forms of binding that collect all the information needed to execute the program. The first form of binding is commonly called early binding (or static dispatch). Object-oriented programming languages use early binding because they typically access the members of an object at compile time. The determination as to which member to choose is done based on the static type of the object. There is one exception to this rule, and is seen in virtual functions of the object-oriented programming languages like C++ and JAVA, where the determination of which function to call is done at runtime.

Dynamically typed programming languages, like Smalltalk and SELF (both send a message to the object to access its member), and virtual functions of C++ and JAVA access the members of an object at runtime, which is the second form of binding commonly called late binding (or dynamic dispatch). This late binding feature allows polymorphism, which is a powerful tool for abstract data types. Even though late binding is slower than early binding to execute a program, it is more powerful and versatile. This is because all members are accessed at compile time, which is when the programmer gets a program ready for use at a later time, as opposed to runtime, which is when a user is ready to use the program.

Polymorphism

Polymorphism is an object's ability to decide which method to apply to itself, depending upon where it is in the inheritance hierarchy. The idea behind polymorphism is that while the message may be the same, objects may respond differently. Polymorphism can be applied to any method that is inherited from a super (parent, or base) class. Polymorphism is only possible in an environment that uses late binding. This means that the compiler does not generate the code to call a method at compile time. Instead, every time a method is applied to an object, the compiler generates code to calculate which method to call, using type information from the object.

In other words, late binding greatly enhances the power of abstract data types by allowing different implementations of the same abstract data type to be used interchangeably at runtime. That is, an invocation of an access to or an operation on an object does not precisely specify which function is executed as a result of the invocation, since late binding selects the appropriate implementation of the operation based on the object's exact type. As encapsulation and dynamic dispatch become pervasive, the resulting code gains flexibility and reusability.

Ideally, every object-oriented programming language should use late binding even for very basic operations such as instance variable access. But unfortunately, late binding creates efficiency problems (which makes them slower to run than programming languages that have static binding): object-oriented programs are harder to optimize than programs written in languages such as C or Fortran, for a couple of reasons. First, object-oriented programming encourages code factoring and differential programming. As a result, procedures are smaller and procedure calls more frequent. Second, it is hard to optimize calls because they use dynamic dispatch: the procedure invoked by the call is not known until runtime because it depends on the dynamic type of the receiver. Therefore, a compiler usually cannot apply standard optimization such as inline substitution or interprocedural analysis to these calls. Consider the following example (written in C++):

class Point {

| | |
|---|---|
| virtual float get_x( ); | // get the x coordinate |
| virtual float get_y( ); | // get the y coordinate |
| virtual float distance (Point p); | // compute distance between receiver |
| | and p |

}

When the compiler encounters the expression p→get₁₃ x( ), where p's declared type is Point, it cannot optimize the call because it does not know p's exact run-time type because, for example, there could be two subclasses of Point, viz. one for Cartesian points and one for polar points.

class CartesianPoint : Point
{

float x, y;
.
.
.
virtual float get_x( ) {return x;}

}
class PolarPoint : Point
{

float alpha, beta;
.
.
.
virtual float get_x( ) {return alpha * cos (beta);}

}

Since p can refer to either a CartesianPoint or a PolarPoint instance at run-time, the compiler's type information is not precise enough to optimize the call. In other words, the compiler knows p's abstract type (i.e., the set of operations that can be invoked and their signatures) but not its concrete type (i.e., the object's size, format, and the implementation of the operations). Therefore, the late bound get_x( ) operation must be compiled as a dynamically dispatched call that selects the appropriate implementation at run-time. What could have been a one-cycle instruction has become a ten cycle call. The increased flexibility and reusability of the source code exacts a significant run-time overhead. In short, encapsulation and efficiency does not coexist in prior art object-oriented programming languages without aggressive optimization, so that has inhibited the user of an object oriented scheme that applies late binding.

### SUMMARY OF THE INVENTION

The present invention provides a method and apparatus for runtime binding of object members. According to one embodiment of the present invention, all class members and class methods (functions) including virtual functions of all objects (classes) of a language are accessed at runtime. This access method is called dynamic loading or late binding. The access to any member or method of any object results in a runtime search (as opposed to a compile time search, which is also called static dispatch or early binding) to find the member or method and to verify that the member or method exists.

According to one embodiment of the present invention, each member of a class has an access control level associated with it. In another embodiment of the present invention an access control protocol is honored by the runtime search to make sure that the user has access to only public members, and does not have access to private members.

### BRIEF DESCRIPTION OF THE DRAWINGS

These and other features, aspects and advantages of the present invention will become better understood with regard to the following description, appended claims and accompanying drawings where:

FIG. 1 is a block diagram that illustrates inheritance in an object-oriented programming language.

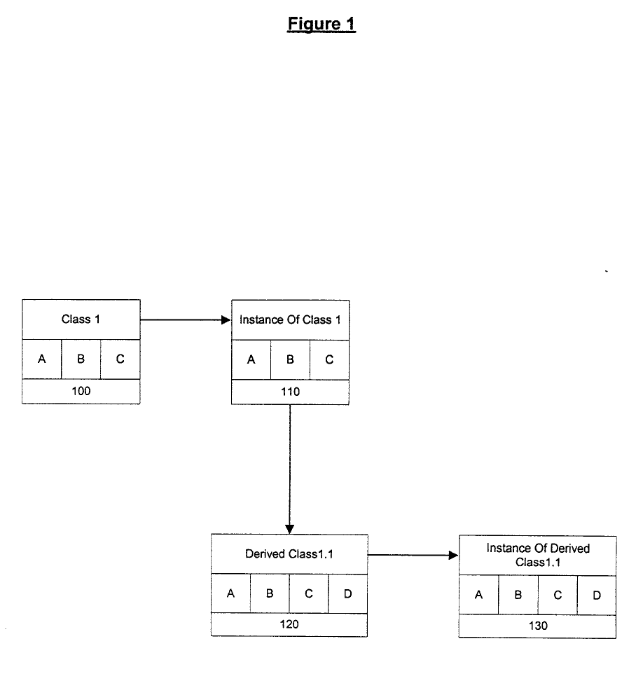

FIG. 2 is a flowchart illustrating the definition of a class in the present invention.

FIG. 3 is a flowchart illustrating the invocation of a function in the present invention.

FIG. 4 is a table of types supported by the present invention.

FIG. 5 is a flowchart illustrating one embodiment of the present invention.

FIG. 6 is a flowchart illustrating one embodiment of late binding according to the present invention.

FIG. 7 is a flowchart illustrating another embodiment of late binding according to the present invention.

FIG. 8 is a flowchart illustrating the embodiment of the present invention where a member of a derived block overrides the member with the same name in the super block.

FIG. 9 is a flowchart illustrating the access control embodiment of the present invention.

FIG. 10 is an illustration of an embodiment of a computer execution environment.

FIG. 11 is a flowchart illustrating how classes and functions are handled by the present invention.

### DETAILED DESCRIPTION OF THE INVENTION

The invention is a method and apparatus for runtime binding of object members. In the following description, numerous specific details are set forth to provide a more thorough description of embodiments of the invention. It will be apparent, however, to one skilled in the art, that the invention may be practiced without these specific details. In other instances, well know features have not been described in detail so as not to obscure the invention.

Object-Orientation

The present invention uses an object-oriented programming language. Even though it has a vast set of data types, it allows a user to define completely new data types using a class block (similar to data type “Class” in other object-oriented programming languages). Classes in the present object-oriented programming language are very similar to other object-oriented programming languages, however, classes in the present object-oriented programming language are closer to the concept of functions, where a function is but an object whose lifetime spans from the time a function is called up to its return. Since the present language is object-oriented, classes of this language can inherit the characteristics of other classes. In fact, since classes and functions are so similar, a function can inherit the characteristics of another function (or any other block type), a feature not seen in prior art object-oriented languages.

Classes and functions are examples of blocks. A function is a block that is called, an activity is performed, and it returns. A class allows the definition of a user-defined type, which can provide a set of operators that operate on objects of that type. The present programming language, like C++, allows the built-in operators of the language to be overridden for a given class.

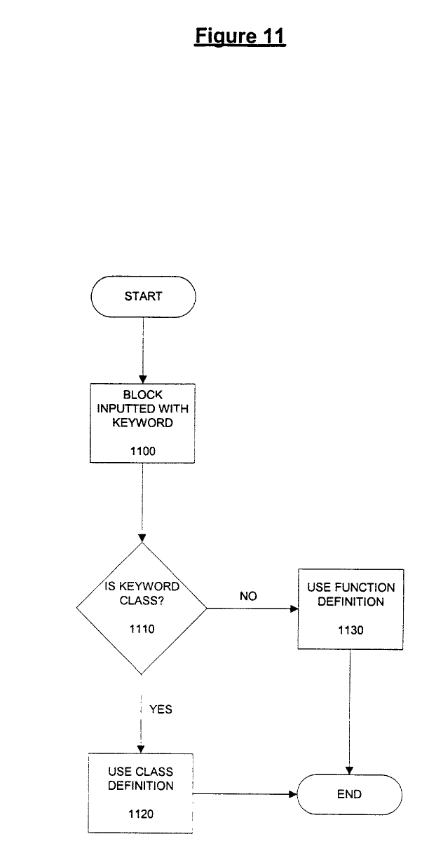

FIG. 11 is a flowchart that illustrates how classes and functions are handled by the present language. At box 1100, a block is inputted with keyword. At box 1110, a check is made to see if the keyword is a class. If it is, then at box 1120 a class definition is used. If on the other hand box 1110 is not a class, then at box 1130 a function definition is used.

Class

A class in the present language is a user defined type. The present language provides a rich set of predefined types for use in programs. When a user defines a class, he/she is extending the set of provided types with one of their own. A class has a body, a set of operators with which to manipulate the body, and may be passed parameters, which are assigned values when the ‘new’ operator is applied to the class creating a new instance of the class (called an Object). The body of the class may contain code that is executed when the instance is created. This code is known as the constructor. For example, the code for declaring a class may look like:

keyword name (arguments){

// class body

}

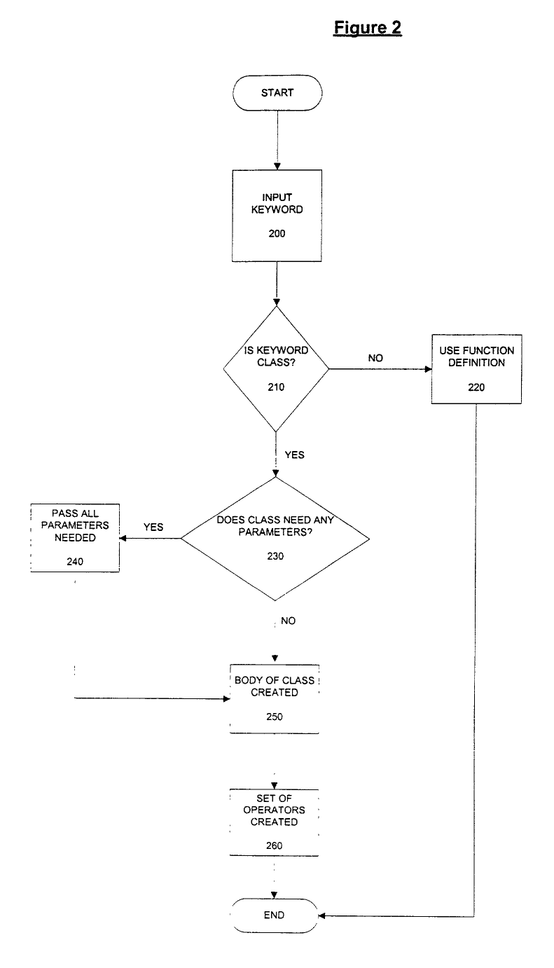

FIG. 2 illustrates the definition of a class as explained above. At box 200, a keyword is inputted by a user. At box 210, a check is made to see if the keyword is class. If it is, then at box 230 a check is made to see if any parameters need to be passed to the defined class. If the class needs any parameters, then at box 240 the necessary parameters are passed to the class. Even if the class needs no parameters, at box 250, the body of the class is made. Next, at box 260, the set of operators with which to manipulate the body are defined. These operators may include the constructor operator that is needed to create a new instance of the class. If box 210 is not a class, then at box 220 a function definition is used since a block in the present language is either a class or a function.

Function

A function is an enclosure containing declarations and code. When a program invokes a function, control transfers to the code of the function. The control returns to the statement after the function call once the function returns. The code for declaring a function is very similar to a class. A function can take a set of parameters, which are assigned values when a function is called. The function can also return a single value to its caller. The only valid operations on a function are to pass it around, to extend it, derive from it, and call it. For example, the code for declaring a function may look like:

keyword name (arguments) {

// function body

}

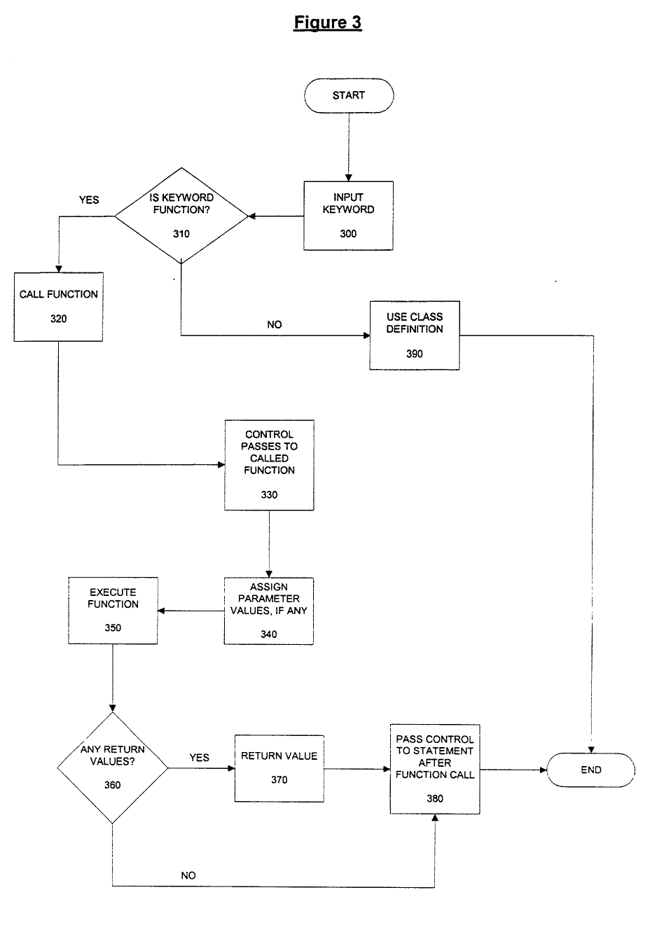

FIG. 3 illustrates the invocation of a function as explained above. At box 300, an keyword is inputted. At box 310, a check is made to see if the keyword is a function. if it is, then at box 320 a function is called. At box 330, control is passed to the called function. At box 340, if there are any parameters that need to be assigned to the function, then they are assigned. At box 350, the function is executed. At box 360, the check is made to see if the function has any return value. If it has a return value, then at box 370, the value is returned. Even if it does not have a return value, at box 380, the control is passed to the statement after the function call. If at box 310, the check to see if the keyword is a function is not true, then at box 390 a class definition is used. The class definition is explained in FIG. 2 above.

The use of a unified scheme for the definition of classes and functions is described more fully in co-pending U.S. application “Method And Apparatus For Unifying The Semantics Of Functions And Classes In A Programming Language”, Ser. No. ______ filed on ______, and assigned to the assignee of this patent application.

Dynamic Types

The present invention uses a dynamically typed programming language unlike prior art object-oriented languages, which are all static languages. The main difference between a dynamic and a static language is that a variable in a dynamic language can take a value of any type rather than have an explicit type when it is declared. For example, in C++ (a static language), variables are declared as follows:

int max=1000, a, b;

std::string name=“Dave”, lastname;

const double pi=3.14159265;

User *p=new User (name), *q=new User (lastname);

The example shows a set of simple variable definitions and declarations. Some of them are initialized with a value (not necessary), and each specifies a type twice. Once for the declared type, and once implied by the initializer. In the example, a, b, and max are defined as variable “integers”, with max initialized to 1000. Each variable in the example, viz. ‘int’, ‘double’, ‘string’, and the pointer ‘*’ are declared once as a type of variable, and a second time when they are initialized. For example, the variable ‘int’ is declared once as a variable type, and declared again when a, b, and max=1000 are assigned ‘int’ values. The same declaration in the present dynamic programming language will look like:

var max=1000, a, b;

var name=“Dave”, lastname;

const pi=3.14159265;

var p=new User (name), q=new User (lastname);

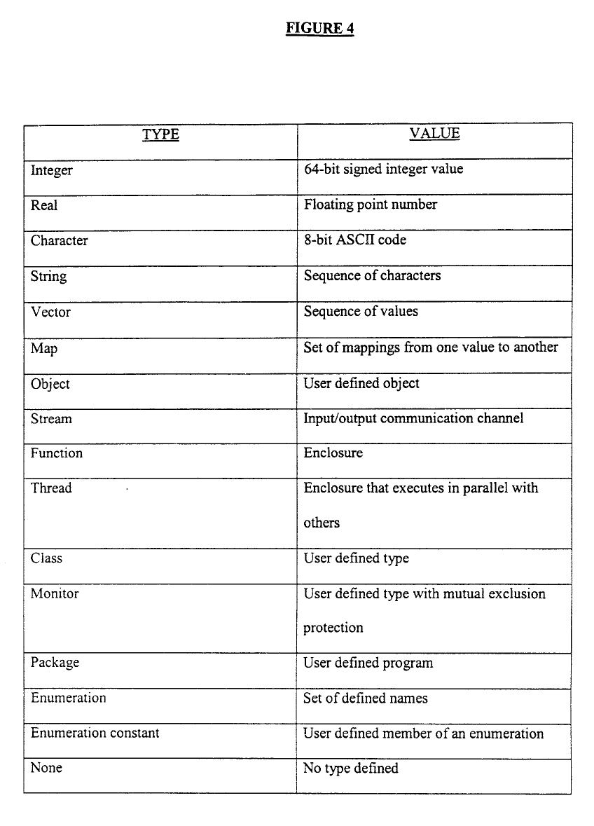

Here there is no type specification for the variable—the type is inferred from the initial value (variables and constants have be initialized in the present programming language). A variable can be declared using the var, const, or generic keywords. For example, a variable declared using the ‘var’ keyword is a constant that can change value, but not type. Similarly, a variable declared using the ‘const’ keyword is a constant that cannot change value, and a variable declared using the ‘generic’ keyword declares a variable that can change both value and type. The table in FIG. 4 gives a list of types supported by the present language. All the usual operators are present in the present language, and can be applied to any of the types, subject to certain rules.

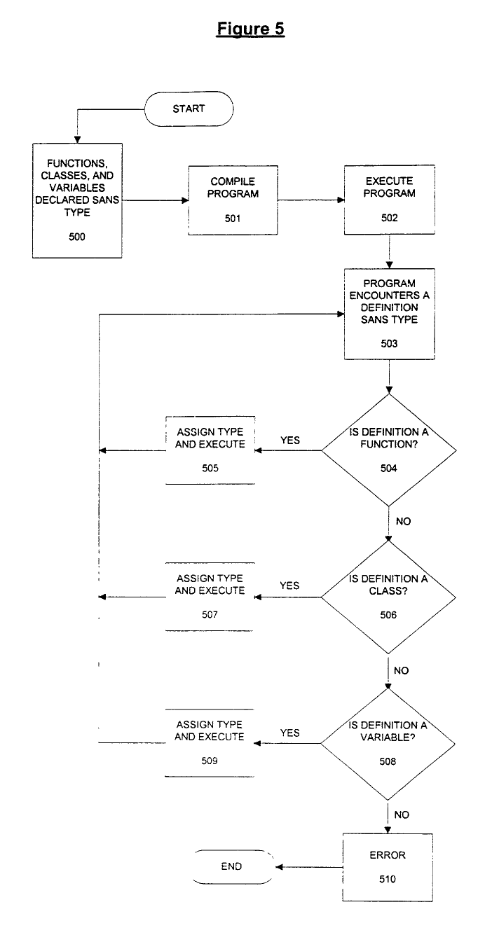

One embodiment of the present invention allows all class members and class methods (functions) including virtual functions of all objects (classes) of the language to be accessed at runtime. This form of binding is commonly known as late binding. FIG. 5 shows this embodiment, where at box 500, all functions, classes, and variables using the present object-oriented programming language are declared without their type. At box 501, the program is compiled. At box 502, the program is executed. At box 503, the program encounters a definition without a type. If at box 504, the execution encounters a function, then at box 505 the function is assigned a type and executed. If not, then at box 506 if the execution encounters a class, then at box 507 the class is assigned a type and executed. If not, then at box 508 if the execution encounters a variable, then at box 509 the variable is assigned a type and executed. If not, then at box 510 an error is declared.

Late Binding

Binding refers to the time when a referred item is linked to a real definition. In other words, when a variable in an expression is referred to, the parser searches for the variable with a certain name and places a pointer to a data structure representing the variable in the expression. Similarly, on reference to a function, the parser searches for the function and places a hard pointer to it. In either case (variable or function), this pointer cannot be changed later on in the program.

When a member function (which is not a virtual function) of an object is referenced through a pointer, the compiler does not make a hard reference to a particular function. Instead, it makes a reference to a description of the function. The real function is determined at runtime when the real type of the object is known. This functionality of late binding is extended to all functions in the present language, not just virtual functions.

According to one embodiment of the present invention, all references to members of blocks are determined at runtime. This means that a reference to a block member can be made in a program before the block is actually defined. It also means that a reference to a block member is made concrete when the actual type of the block is determined at runtime.

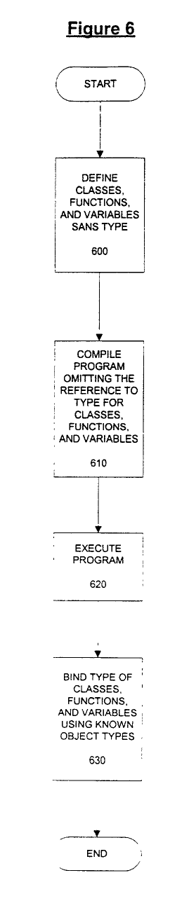

FIG. 6 illustrates one embodiment of late binding according to the present invention. At box 600, all classes, functions, and variables are defined sans type. At box 610, the program is compiled omitting the reference to type of classes, functions, and variables. At box 620, the program is executed. At box 630, the type of classes, functions, and variables are bound using known object types.

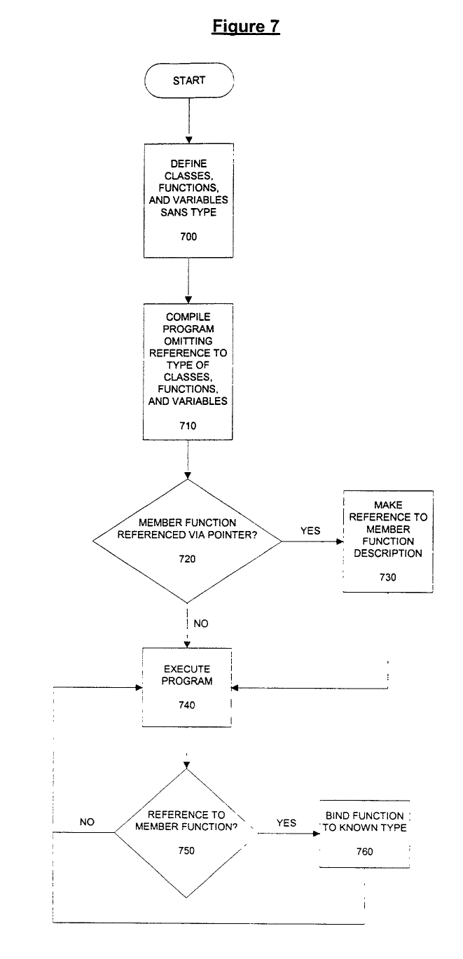

FIG. 7 illustrates another embodiment of late binding according to the present invention. At box 700, all classes, functions, and variables are defined sans type. At box 710, the program is compiled omitting the reference to type of classes, functions, and variables. At box 720, the check is made to see if a member function is referenced through a pointer. If it is, then at box 730 a reference is made to the description of the member function, before the program is executed at box 740.

If at box 720 the member function is not referenced via a pointer, then the program continues to be executed at box 740. At box 750, the check is made to see if a reference is made to a member function. If it is, (and since the type of the member function is now known—the real function is determined at runtime when the real type of the object is known), then at box 760 the member function is bound to the known type, otherwise the program continues to run.

The C++ concept of a virtual function is the normal access method for all blocks in the present language. If a derived block provides a member that itself is a block and that member matches the name of a block in a superblock (analogous to a base class in C++), then it behaves similar to C++'s method override functionality. In effect, it replaces the superblock's member.

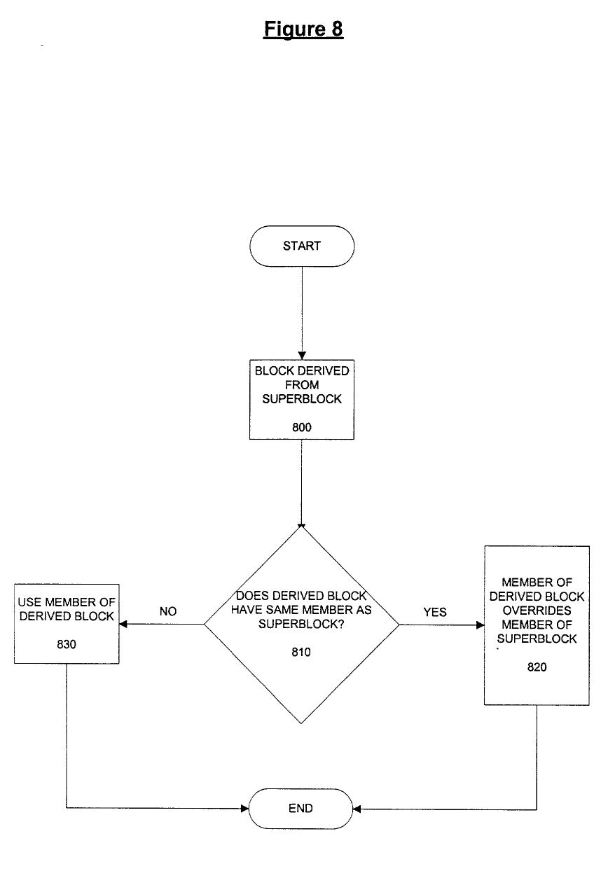

FIG. 8 shows the embodiment of the present language where a member of a derived block overrides the member with the same name in the superblock. At box 800 a block is derived from a super or parent block. At box 810, if the derived block has a member that matches a member in the superblock, then at box 820 the superblock member is overwritten. If on the other hand, the derived block has a member that is not seen in the superblock, then at box 830 the member of the derived block is compiled and used at runtime whenever a reference is made to it.

Virtual Functions

The present language does not have the concept of a virtual function. In fact, it does not have the concept of a non-virtual function either, as all block members are inherently “virtual”. If a derived block provides a member with the same name and number of parameters as an accessible member in a base block, then the derived block member overrides the member in the base block. This only applies to block members that are themselves blocks (functions, classes, etc.). For example:

| | |
|---|---|
| class A { | |
| private function f { | // private function |
| } | |
| public function g { | // protected function g is also ok |
| } | |
| } | |
| class B : A { | // A is base block of B, or B is derived from A |
| private function f { | // no override here |
| } | |
| private function g { | // overrides public function g of class A |
| } | |
| } | |

Because the resolution of block members is done at runtime rather than at compile time, the override of a block member only comes into effect if the override member is invoked from within the base class. For example:

class A {
private function f { // private function

System.println (“A.f”)
}

public function g {

System.println (“A.g”)
}

function show {
f( )
g( )
}

}
class B : A { // A is base block of B, or B is derived from A
privatefunction f {// no override here

System.println (“B.f”)
}

public function g { // overrides public function g of class A

System.println (“B.g”)
}

}
var a = new A( )
var b = new B( )

| | |
|---|---|
| a.f( ) | // prints A.f |
| a.g( ) | // prints A.g |
| a.show( ) | // prints A.f followed by A.g |
| b.f( ) | // prints B.f |
| b.g( ) | // prints B.g |
| b.show( ) | // prints A.f followed by B.g |

This mechanism allows a derived block to change block type of a member in a base block, and is especially useful, for example, when a function in a base block needs to be changed into a thread.

Access Control

One embodiment of the present invention provides the programmer with control over the access to members of blocks. The runtime search honors an access control protocol to make sure that a user has access to only public members, and does not have access to private members. All declarations in the present invention have an access mode associated with it, and include:

Public—members available to all.

Protected—members who are available to only the block it belongs to, and to derived blocks thereof.

Private—members who are available to only the block it belongs to.

The access to a block member is determined at runtime when the actual block member is determined (refer to the late binding section above). It is important to note one major difference between the present language and prior art object-oriented languages, which is that in the present language all members have an access mode, not just class members, even though a function may provide both public or protected members. Since the present language provides inheritance, a function can provide a public interface that is accessible to other functions or classes derived from it. For example:

function A {

private var a = 1
public var b = 2

}
function B : A { // A is base block of B, or B is derived from A

var x = a // error: a is not accessible
var y = b // ok: b is a public member

}

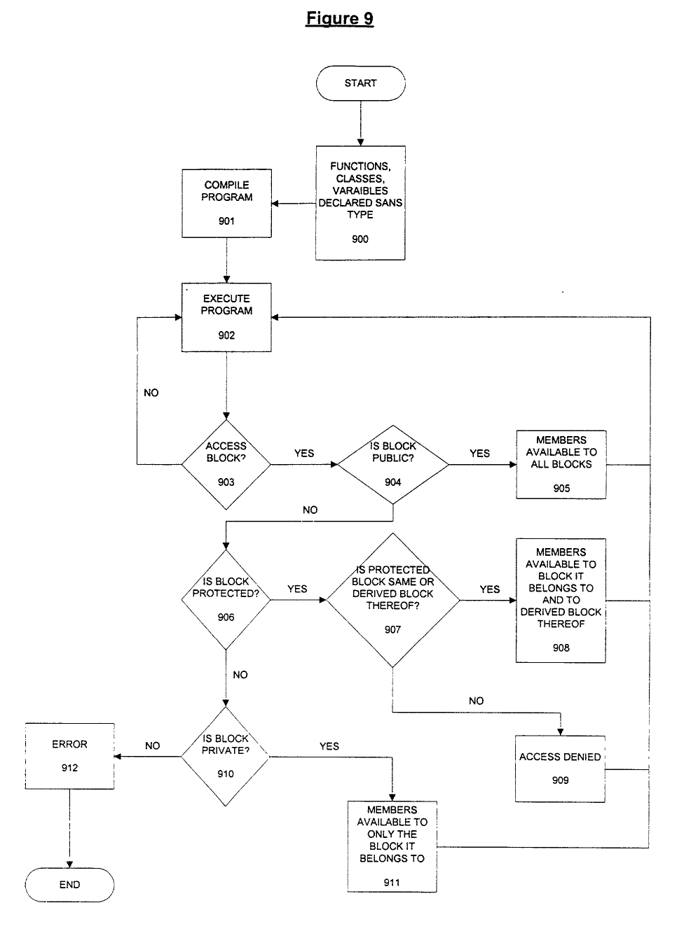

FIG. 9 illustrates the embodiment of access control of the present invention. At box 900, all classes, functions, and variables are defined sans type. At box 901, the program is compiled omitting the reference to type of classes, functions, and variables. At box 902, the program is executed. At box 903, if access is made to a block, then at box 904 a check is made to see if the block is public. If on the other hand, access is not to a block, then the program continues to execute at box 902. If at box 904 the access is to a public block, then at box 905 the members of that public block are available to all. If on the other hand, the access is not to a public block, then at box 906 a check is made to see if access is to a protected block. If it is, then at box 907 a check is made to see if access is to the same block or a derived block thereof. If it is, then at box 908 members of that block are available to the block it belongs to and to derived blocks thereof. If on the other hand, box 907 is not an access to the same block or a derived block thereof, then at box 909 access is denied. If at box 906 access is not to a protected block, then at box 910 a check is made to see if access is to a private block. If it is, then at box 911 members are available to only the block it belongs to. If on the other hand, the access is not to a private block, then at box 912 the access is labeled an error.

Embodiment of a Computer Execution Environment

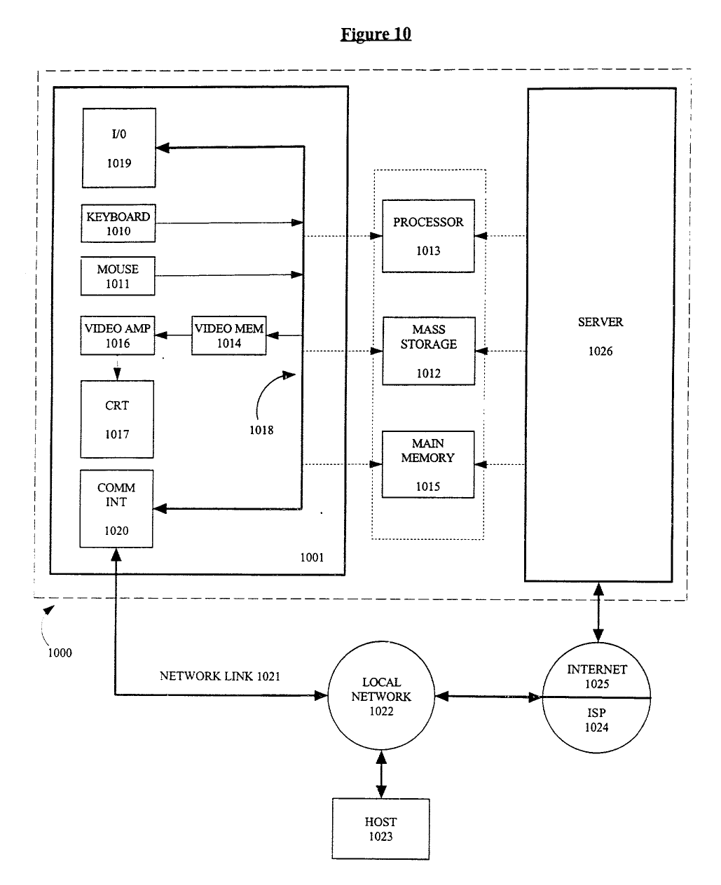

An embodiment of the invention can be implemented as computer software in the form of computer readable code executed in a desktop general purpose computing environment such as environment 1000 illustrated in FIG. 10, or in the form of bytecode class files running in such an environment. A keyboard 1010 and mouse 1011 are coupled to a bi-directional system bus 1018. The keyboard and mouse are for introducing user input to a computer 1001 and communicating that user input to processor 1013.

Computer 1001 may also include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals, which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals, which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device, Internet ready cellular phones, and other Internet computing devices.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014, and mass storage 1012. Alternatively, multiplex data/address lines may be used instead of separate data and address lines.

In one embodiment of the invention, the processor 1013 is a microprocessor manufactured by Motorola, such as the 680×0 processor or a microprocessor manufactured by Intel, such as the 80×86 or Pentium processor, or a SPARC microprocessor from Sun Microsystems, Inc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code may be executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022, and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system.

Thus, a method and apparatus for runtime binding of object members is described in conjunction with one or more specific embodiments. The invention is defined by the following claims and their full scope of equivalents.

We claim:

1. A method for binding an object member at runtime comprising: declaring said object member in a program written in a dynamically typed programming language; and
running said program comprising,
determining whether said object member is used; and
binding said object member to its reference if said object member is used.

2. The method of claim 1 wherein said object member is a class member of said dynamically typed programming language.

3. The method of claim 1 wherein said object member is a class method of said dynamically typed programming language.

4. The method of claim 3 wherein said class method is a virtual method of an object of said dynamically typed programming language.

5. The method of claim 1 further comprising:
using an access control level wherein a public member and a private member have different access rights.

6. A computer program product comprising:
a computer useable medium having computer readable program code embodied therein configured to bind an object member at runtime, said computer program product comprising:
computer readable code configured therein to cause a computer to declare said object member in a program written in a dynamically typed programming language; and
computer readable code configured therein to cause a computer to run said program comprising,
computer readable code configured therein to cause a computer to determine whether said object member is used; and
computer readable code configured therein to cause a computer to bind said object member to its reference if said object member is used.

7. The computer program product of claim 6 wherein said object member is a class member of said dynamically typed programming language.

8. The computer program product of claim 6 wherein said object member is a class method of said dynamically typed programming language.

9. The computer program product of claim 8 wherein said class method is a virtual method of an object of said dynamically typed programming language.

10. The computer program product of claim 6 further comprising:
an access control level wherein a public member and a private member have different access rights.
